(19) United States
(12) Patent Application Publication
(10) Pub. No.: US 2012/0265605 A1
(43) Pub. Date: Oct. 18, 2012

(54) MOBILE COUPON BASKET

(75) Inventors: Tarun Bhatia, Simi Valley, CA (US); Ayman Farahat, San Francisco, CA (US); Dipika Bhatia, Simi Valley, CA (US)

(73) Assignee: Yahoo! Inc., Sunnyvale, CA (US)

(21) Appl. No.: 13/088,257

(22) Filed: Apr. 15, 2011

(51) Int. Cl. G06Q 30/00

(52) U.S. Cl. 705/14.41

(57) ABSTRACT

Techniques are provided in which an advertisement basket application is provided to a user, such as a mobile user, through which the user can store advertisements, including promotions or coupons, as the user enters or encounters them online. Stored advertisements may include advertisements that are or are incorporated into applications with which the user may interact over time. Upon detection of a triggering condition or conditions indicating a potential use of a stored advertisement, an electronic alert is provided to the user. User interaction with stored advertisements is tracked and used in measuring advertisement performance, which may include brand engagement value.

### BACKGROUND

Online users are often not averse to certain types of advertisements, such as premium and useful advertisements, online. In fact, they often expect such advertisements to subsidize their free Web usage. However, to encourage usage and enhance effectiveness, advertisements need to be consistent with users' motivations, and not violate or degrade their overall experience. Furthermore, user activities, including content consumption, are shifting, from such things as search and selection of sites and articles, to activities such as interacting via applications, on mobile and social platforms, for example.

There is a need for more effective advertising related techniques.

### SUMMARY

Some embodiments of the invention provide systems and methods in which an advertisement basket application is provided to a user. Through the application, the user can store advertisements, including promotions or coupons, as the user encounters them online, as well as tag data about stored advertisements. The user can later search for and retrieve a stored advertisement for use at an appropriate time. Stored advertisements may include advertisements that are or are incorporated into applications with which the user may interact over time. User interactions with stored advertisements can be used in measuring advertisement and campaign performance, which may include brand engagement value.

Some embodiments of the invention provide systems and methods in which an advertisement basket application is provided to a user, such as a mobile user, through which the user can store advertisements, including promotions or coupons, as the user encounters them online. Stored advertisements may include advertisements that are or are incorporated into applications with which the user may interact over time. Upon detection of a triggering condition or conditions indicating a potential use of a stored advertisement, an electronic alert is provided to the user. User interaction with stored advertisements is tracked and used in measuring advertisement performance, which may include brand engagement value.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a flow diagram illustrating a method according to one embodiment of the invention;

FIG. 6 is a flow diagram illustrating a method according to one embodiment of the invention;

FIG. 7 is a flow diagram illustrating a method according to one embodiment of the invention;

FIG. 8 is a block diagram illustrating one embodiment of the invention; and

FIG. 9 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

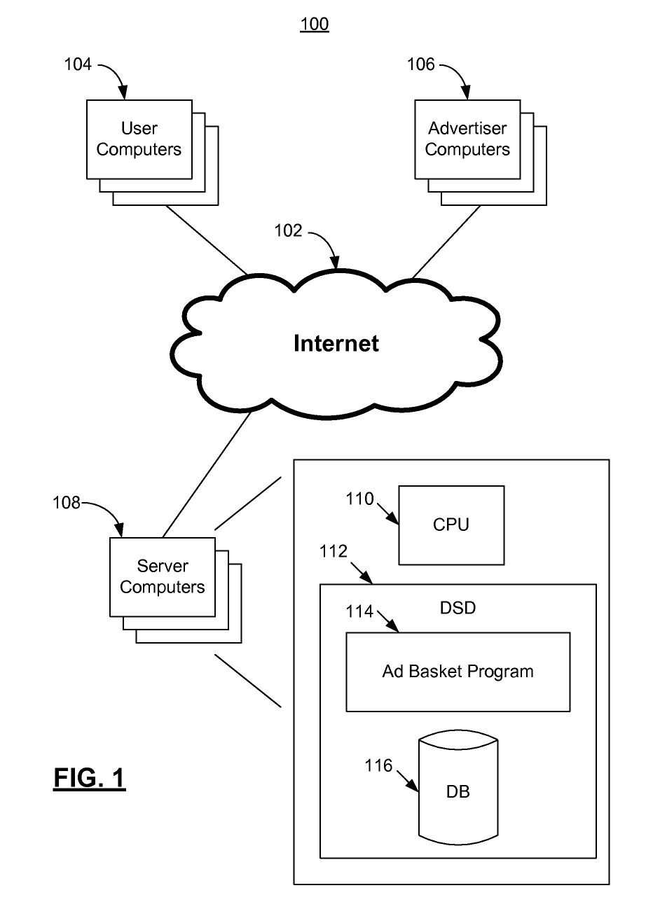

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Herein, the term “advertisement” is intended to be broadly defined, and includes, among other things, coupons, discounts, promotions, textual advertisements, rich advertisements, mobile advertisements, video advertisements, social networking related advertisements, mobile advertisements, etc.

As depicted, each of the server computers 108 includes one or more CPUs 110 and a data storage device 112. The data storage device 112 includes a database 116 and Ad Basket Program 114.

The Program 114 is intended to broadly include all programming, applications, algorithms, software and other and tools necessary to implement or facilitate methods and systems according to embodiments of the invention, including Ad Basket and Ad Basket Application elements as well as Coupon Basket/Mobile Coupon Basket and Coupon Basket Application/Mobile Coupon Basket Application elements. Herein, a Coupon Basket or Coupon Basket Application can be or include Mobile Coupon Basket or Mobile Coupon Basket Application. The elements of the Program 114 may exist on a single server computer or be distributed among multiple computers or devices. Furthermore, in some embodiments, the program 114 may be included or partially included or implemented on one or more client computers or devices.

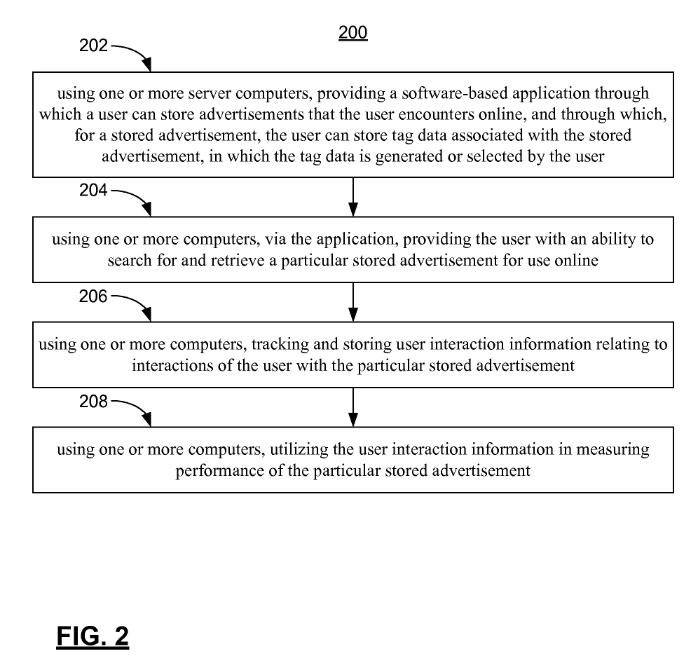

FIG. 2 is a flow diagram illustrating a method 200 according to one embodiment of the invention. Step 202 includes, using one or more server computers, providing a software-based application through which a user can store advertisements that the user encounters online, and through which, for a stored advertisement, the user can store tag data associated with the stored advertisement, in which the tag data is generated or selected by the user. In some embodiments, in addition to encountering coupons, etc., online, a user may enter coupons, etc., such as through an online interface, that the user may come across offline. This can include, for example, physical coupons, cut-out coupons, magazine or circular coupons from stores, etc.

In some embodiments, even though an ability to tag advertisements may be provided to a user, the user may simply store and retrieve advertisements, or some advertisements, without including or using tags or tag data. Additionally, in various embodiments, an ability to tag advertisements may or may not be provided to users.

Step 204 includes, using one or more computers, via the application, providing the user with an ability to search for and retrieve a particular stored advertisement for use online.

Step 206 includes, using one or more computers, tracking and storing user interaction information relating to interactions of the user with the particular stored advertisement.

Step 208 includes, using one or more computers, utilizing the user interaction information in measuring performance of the particular stored advertisement.

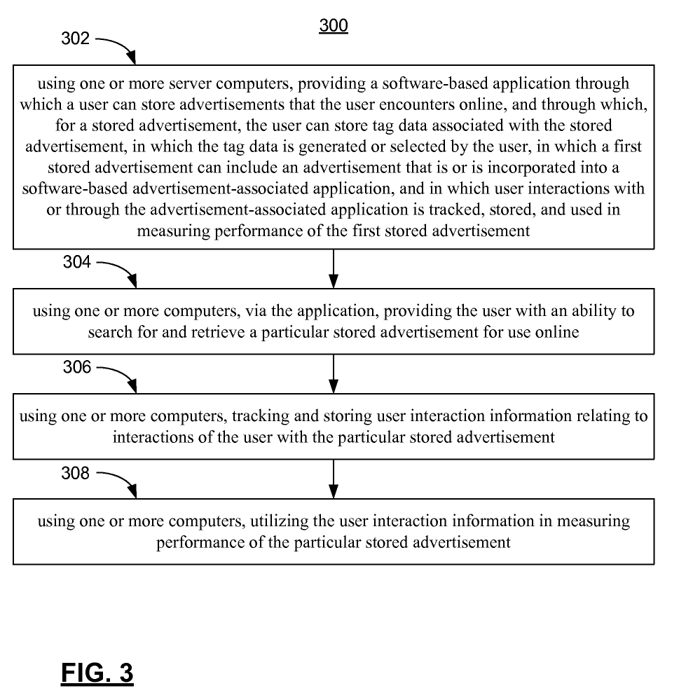

FIG. 3 is a flow diagram illustrating a method 300 according to one embodiment of the invention. Step 302 includes, using one or more server computers, providing a software-based application through which a user can store advertisements that the user encounters online, and through which, for a stored advertisement, the user can store tag data associated with the stored advertisement. The tag data is generated or selected by the user. Furthermore, a first stored advertisement can include an advertisement that is or is incorporated into a software-based advertisement-associated application. User interactions with or through the advertisement-associated application are tracked, stored, and used in measuring performance of the first stored advertisement.

Step 304 includes, using one or more computers, via the application, providing the user with an ability to search for and retrieve a particular stored advertisement for use online.

Step 306 includes, using one or more computers, tracking and storing user interaction information relating to interactions of the user with the particular stored advertisement.

Step 308 includes, using one or more computers, utilizing the user interaction information in measuring performance of the particular stored advertisement.

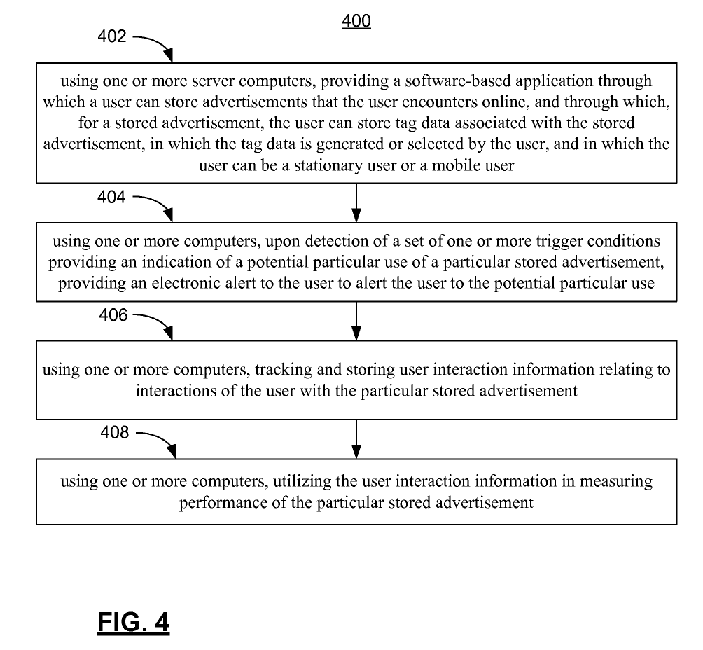

FIG. 4 is a flow diagram illustrating a method 400 according to one embodiment of the invention. Step 402 includes, using one or more server computers, providing a software-based application through which a user can store advertisements that the user encounters online, and through which, for a stored advertisement, the user can store tag data associated with the stored advertisement, in which the tag data is generated or selected by the user, and in which the user can be a stationary user or a mobile user.

Step 404 includes, using one or more computers, upon detection of a set of one or more trigger conditions providing an indication of a potential particular use of a particular stored advertisement, providing an electronic alert to the user to alert the user to the potential particular use.

Step 406 includes, using one or more computers, tracking and storing user interaction information relating to interactions of the user with the particular stored advertisement.

Step 408 includes, using one or more computers, utilizing the user interaction information in measuring performance of the particular stored advertisement.

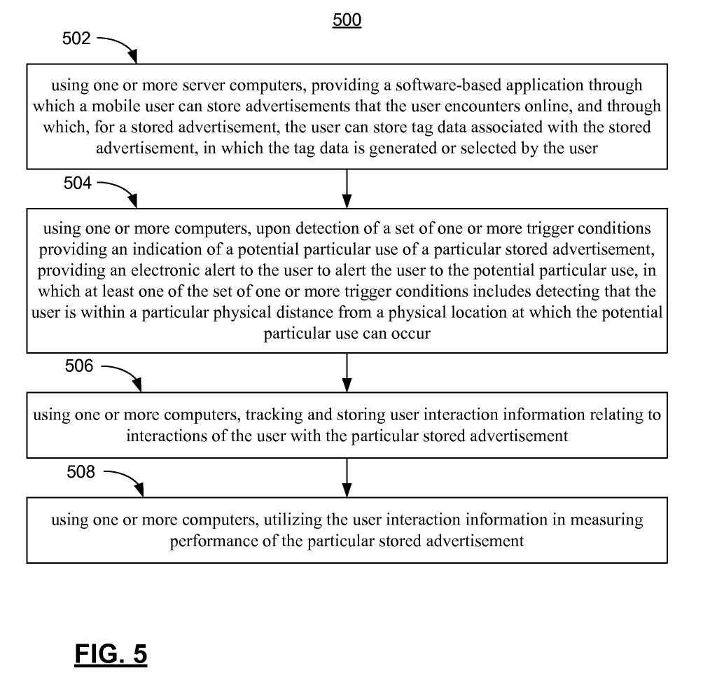

FIG. 5 is a flow diagram illustrating a method 500 according to one embodiment of the invention. Step 502 includes, using one or more server computers, providing a software-based application through which a mobile user can store advertisements that the user encounters online, and through which, for a stored advertisement, the user can store tag data associated with the stored advertisement, in which the tag data is generated or selected by the user.

Step 504 includes, using one or more computers, upon detection of a set of one or more trigger conditions providing an indication of a potential particular use of a particular stored advertisement, providing an electronic alert to the user to alert the user to the potential particular use, in which at least one of the set of one or more trigger conditions includes detecting that the user is within a particular physical distance from a physical location at which the potential particular use can occur.

Step 506 includes, using one or more computers, tracking and storing user interaction information relating to interactions of the user with the particular stored advertisement.

Step 508 includes, using one or more computers, utilizing the user interaction information in measuring performance of the particular stored advertisement.

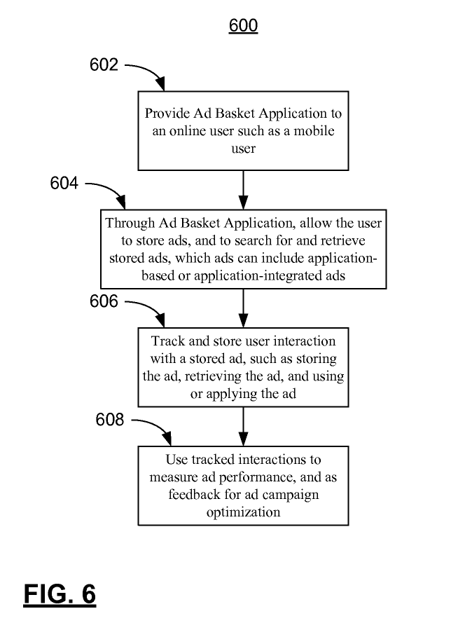

FIG. 6 is a flow diagram illustrating a method 600 according to one embodiment of the invention. Step 602 includes providing an Ad Basket Application to an online user such as a mobile user.

Step 604 includes, through Ad Basket Application, allowing the user to store ads, and to search for and retrieve stored ads, which ads can include application-based or application-integrated ads.

Step 606 includes, tracking and storing user interaction with a stored ad, such as storing the ad, retrieving the ad, and using or applying the ad.

Step 608 includes using tracked interactions to measure ad performance, and as feedback for ad campaign optimization.

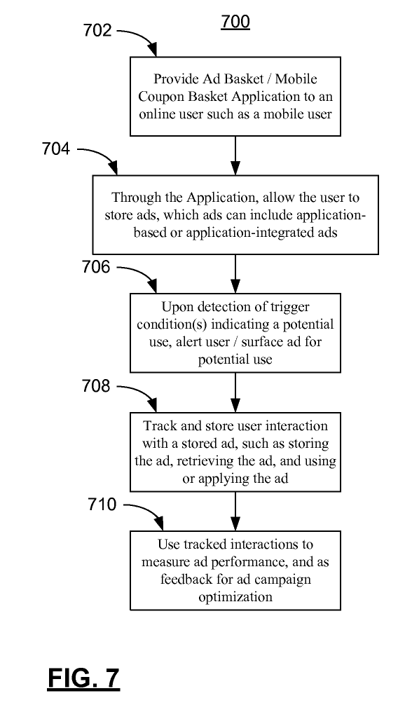

FIG. 7 is a flow diagram illustrating a method 700 according to one embodiment of the invention. Step 702 includes Provide Ad Basket/Mobile Coupon Basket Application to an online user such as a mobile user.

Step 704 includes, Through the Application, allowing the user to store ads, which ads can include application-based or application-integrated ads.

Step 706 includes, upon detection of trigger condition(s) indicating a potential use, alert user/surface ad for potential use.

Step 708 includes, tracking and storing user interaction with a stored ad, such as storing the ad, retrieving the ad, and using or applying the ad.

Step 710 includes using tracked interactions to measure ad performance, and as feedback for ad campaign optimization.

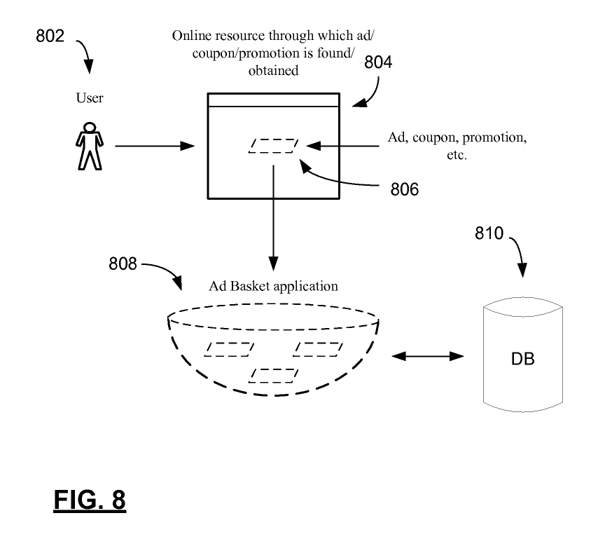

FIG. 8 is a block diagram 800 illustrating one embodiment of the invention. An online user 802 is depicted, interacting with an online resource 804, such as an application, tool, service, Web site, etc., through which a conceptually depicted ad/coupon/promotion 806 is found or obtained.

As depicted, the ad/coupon/promotion 806 is saved using a conceptually depicted Ad Basket Application 808 (which can be or include a Mobile Coupon Basket Application), which Application 808 may include various other functionality. The Application 808 may be coupled to a database 810 (which may or may not be part of the Ad Basket Application) at which some or all information relating to ads/coupons/promotions is stored.

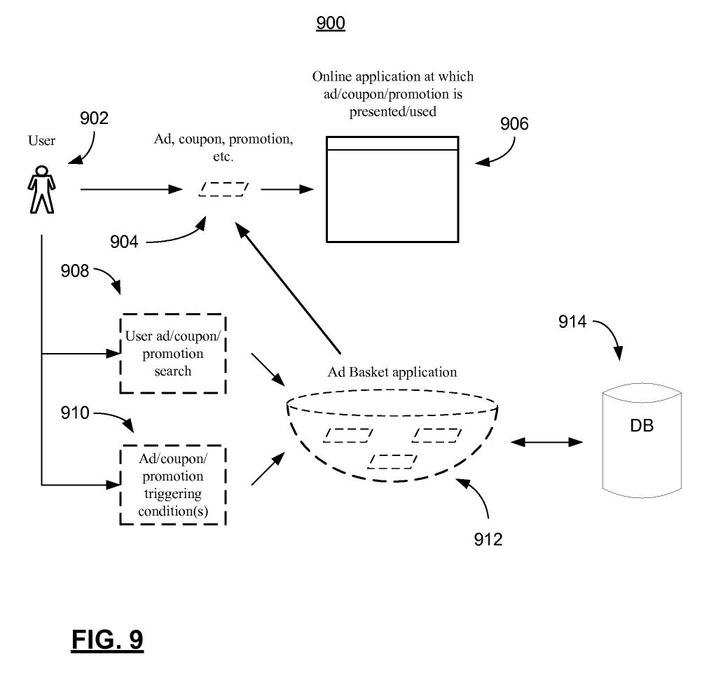

FIG. 9 is a block diagram 900 illustrating one embodiment of the invention. An online user 902 is depicted, interacting with an online resource 906, such as an application, tool, service, Web site, etc., at which a conceptually depicted ad/coupon/promotion 904 is presented or used, or partially presented or used. The ad/coupon/promotion 904 may be presented or used by the user, such as after being surfaced, such as by alerting the user, by the Ad Basket Application 912. Alternatively, the ad/coupon/promotion 904 may be presented or used, or partially presented or used, by an Ad Basket application 912, with limited or without any action of the user 902, such as upon detection of appropriate conditions and/or circumstances.

In some embodiments, the Ad Basket Application 912 may include (or may interact with) a search tool, through which the user 902 may conduct a search 908, such as a keyword search, search based on a Web site, etc., to find one or more ads/coupons/promotions, for potential use with a resource such as a Web site, application, etc.

Furthermore, in some embodiments, one or more trigger conditions 910 may cause an appropriate ad/coupon/promotion 904 to be surfaced, such as by alerting the user 902, or may cause the ad/coupon/promotion 904 to be presented or used with only user approval, or even without any user 902 action. A triggering condition may include one or more online or offline conditions, such as the user 902 entering within a certain distance (as may be determined based on GPS, for example, in relation to a mobile device of the user, for example) of a location at which a particular ad/coupon/discount may be used. On online condition could include the user visiting a certain Web site or application, interacting in a particular way with a Web site of application, or many other possible conditions.

In some embodiments of the invention, ads/coupons/promotions can be or include applications through which a user may interact over time, such as, for example, a branded avatar or virtual item, or any of various other types of applications which may also serve to advertise, such as by positively promoting a brand, for example. Such advertisement may include advertisements which may be imported, for use, into applications by a user. Such advertisements, which may include application-based advertisements can provide user incentive, provide long-lasting advertising value, and allow tracking of particular user interactions and advertisement performance over time. Advertisements including those of the foregoing sorts, such as application-based or application-associated advertisements with which users may interact over time and/or may integrate or import into applications that the user uses, may be termed “life-vertisements.” In some embodiments of the present invention, ads/coupons/promotions can include life-vertisements, and some embodiments of Ad Basket Applications accommodate and can be designed to be used with life-vertisements.

Some embodiments of the invention provide systems and methods to allow users to tag (broadly defined to include any of various informational associations by a user, etc.), such as mark, and retrieve ads previously served to them by an ad server, which may provide additional events of value to estimate campaign effectiveness and ad engagement for brand advertisers, for example. Essentially, some embodiments extend the timeframe for an ad to generate a performing event from an instant click at the time of serving, to a recall at some later time initiated by the same user, such as by the use and integration of application-based advertisements, for example.

Some embodiments include a recognition that brand advertisers, for example, seek engagement and brand favorable response, even though they continue to buy impressions. Not all impressions are alike the level of engagement achieved with users. In an effort to provide meaningful performance feedback on the campaign exposure, it can be important to move beyond reach, frequency, and impressions at buying towards the extent of brand lift achieved and engagement delivered by the campaign.

Some embodiments of the invention include use of advertisements, such as life-vertisements, which can be viewed as evolved ads in that they contain application objects that can be imported into an application context by the user. This user action is considered a special event that contributes to brand lift metrics. Beyond the impression, and the user import of the object, the branded object continues to enrich the user's experience within an application context. Every time it is used within the application, it continues to generate statistics for the campaigns effectiveness for brand metrics.

Users occasionally do re-visit a magazine for an ad they remember seeing and want to dig up. This can be viewed as lacking in certain ways online. In some embodiments, the Ad Basket can be an application offered by the ad server for the ad network, and ads served could be considered objects within it that a user can additionally tag upon an ad view.

Additionally, in some embodiments, users shall be able to go to the Ad Basket at any time and pull up, search for, or step through ads served to them to locate an ad that they seek. Their activity within the Ad Basket will generate additional brand metrics for the performance evaluation of the ad or campaign.

Some embodiments include a recognition that users' content consumption is moving from search and selection of sites and articles, to interacting via applications within sites, on mobile and social platforms. Brand advertisers seek engagement with target audiences, but continue to buy impressions. One way to provide engagement measurements is to oat out application objects via advertisements online, and instrument the usage and utility patterns of the users thereafter. A second way to advance this goal is to let users interact with the ads served over an extended period of time, which can be accomplished by Ad Basket applications in some embodiments. In some embodiments, regardless of the ad view being just an impression of a creative, or a point of distribution for an application object, users would be able to go to the Ad Basket at any time and pull up the ad (and inherent object).

Some embodiments include the following. Ads may be mapped to cookies, unique user ids, or user session information. Users may have the ability to tag, such as mark, ark, and save impressed ads at the time of impression into the Ad Basket for future interaction. Users may have the ability to configure ad basket rules controlling the types of ads to be logged or not logged by the Basket by default for potential surfacing at a later time. The ad server may be able to provide an application interface to the Ad Basket Application for a user to retrieve ads via searching by attributes, by time, by session etc, and may be able to capture Ad Basket data events for potential generation of brand favorability metrics of online ad campaigns.

In some embodiments, the ad network would offer the ability for users to tag, label, share, or save the ad to the Ad Basket Application, in addition to clicking the ad and going to the recommended landing page, for example. In addition, it would also work for the life-vertisement ads that may contain an application object that is instrumented for brand impact. In some embodiments, a user served the ad may click the ad upon viewing; tag, such as mark, or save the ad to the Ad Basket; or not do anything at all. If the user does nothing with the ad and wants to retrieve the ad at some later point, they the user may, for example, simply visit the application interface for the Ad Basket with his or her account information (credentials—session, cookies or unique user id may be required, for example) and simply step through or search by attributes such as advertiser, category, or campaign key word. If the user saves the ads explicitly or applies special tags, these may additionally be available as search attributes in retrieval. All interactions that the user would perform with the ad at view time may then be available for the user to perform when retrieving the ad from the Ad Basket. In some embodiments, essentially, the ad lives on beyond its view according the

In some embodiments, the Ad Basket Application is offered by an ad network. Some embodiments include instrumentation for Ad Basket activity with campaigns and ads served by the network to provide performance feedback. Resulting performance statistics may be employed by the network in measuring campaign effectiveness. Some embodiments may include packaging of usage statistics for a user and user target segments in determining brand favorability. Some embodiments may also include packaging measurements on usage statistics for a campaign in the Ad Basket to provide brand metrics to advertiser.

Furthermore, some embodiments include potential targeting of users, such as users that are heavy users of Ad Baskets (such as including sharing ads, retrieving ads, tagging ads, etc.). Some embodiments also include taking users' selections and preferences for ads recalled to indicate preference, aggregations of which provide market research on the products and their mix of features (colors of a phone, for example), or other surveys. Some embodiments include using data collected on user preferences to classify users into targeting segments for targeting creatives later on, for that brand or product.

Some embodiments of the invention include an Ad Basket Application that can be viewed as, or can be or include, a Mobile Coupon Basket Application. In some embodiments, systems and methods are provided for users, such as consumers, to centrally store and pro-actively redeem promotional offers from advertisers in a seamless context-aware manner. The promotions may be generally offered by advertising entities or targeted specifically to the user via an ad impression through an ad network, for example. In some embodiments, as a positive additional effect, interaction events generated for the user within this application, pertaining to intent or actual redemption, will generate signals to estimate campaign effectiveness and return on investments for promotional activities for the advertiser. Some embodiments include a focus to make it easier for users to redeem coupons they may be aware or unaware of while consuming goods and services using their device of choice, such as a mobile device, in any shopping experience, for example.

Generally, many coupons are floated out in print, circulars, and electronic format but not through an ad network. Offering this service may benefit advertisers, ad networks, and the audience network that distributes these promotional offers via the ad units. Event stream data on interaction with the coupon, saving and applying the coupon, whether online or at a physical outlet, will generate specific data on users to monitor and facilitate effective deployment of promotional marketing and brand building activities against the marginal revenue loss from running the promotions. In some embodiments, the promotional offer may be little or no different in provisioning than an ad. In some embodiments, however, it may leverage use of life-vertisements to deliver an object via the ad that interacts with the Coupon Basket Application.

In some embodiments, users may interact with the Coupon Basket Application on the Web or mobile platform. The mobile platform may be location aware. Users may easily be able to set rules to pull promotional offers, or surface them automatically move these to the coupon basket application. The Coupon Basket Application may be or include a form of Ad Basket Application which includes allows retrieval of past saved or tagged ads, in turn generating brand feedback and extending the life of an ad view, for example. In some embodiments, the Coupon Basket Application actively participates in a user's context, validates and resolves coupons when in an activated state, and surfaces up alerts to the user when an opportunity to apply a coupon presents itself in the course of a user's natural activity, or presents or uses a coupon without user action. By enabling users to save time and money while shopping, it may further enable discovery of additional goods and services. The Coupon Basket may influence action and go beyond capturing intent, which is something that has made search advertising, for example, so valuable. Users may favor this application and adopt for its ubiquity and coverage (in terms of their consumption profiles). Social or social networking alerts could also boost adoption. As the network adoption grows, more advertisers and users may rely on this platform to employ coupons.

Some embodiments include a recognition that consumers may face the following issues, among others: receive coupons and promotions from many different channels (email, websites, print media, mailers, etc.); coupons and promotions require different redemption mechanisms (take to store, enter code); coupons and promotions come in many types and deal terms but have some structure worth exploiting; physical coupons are easy to leave behind unless once is disciplined, etc. For such reasons, not all the coupons that a user saves or intends to use actually get used. This is savings from the wallets of users that is passed up. Some embodiments address these and other issues, while not creating any additional burden on them than turning on an application and occasionally responding to a promotional offer by clicking, for example.

Some embodiments include a recognition that advertisers may view promotional coupons as necessary evils. These may be levers that come at the expense of marginal sales revenue and brand dilution but allow the advertiser to increase awareness, clear inventory, or boost temporal interest in the company, brand, or product. While it may be not in their interest that the redemption rate of coupons increase, this is still desirable if the coupons are traced back to the marketing activities and the intent signal is clarified. In some embodiments, with the Coupon Basket, analytics will be available by processing the interaction with coupon objects to provide advertisers this information, that may pay off in terms of better targeting of promotional dollars. For instance, consumers could be separated on high marginal return on coupon and promotional dollars redeemed (shop only with coupon, versus visit the store and buy more than was discounted, for example). An ad network that offers this service may benefit from network effects in becoming a platform of choice for standardizing the digital coupon object, for example.

Some embodiments provide and utilize, for example, a language to express the structure of the coupon or promotion, and the conditions for its validity may be expressed, for example, in terms of required spend thresholds, purchasing specific items, redemption limits, or expiration date, etc. In some embodiments, in the backend, the Coupon Basket would be aware of the user's context (searching for a blu ray player, reading about a review of players, etc.) and alert the user of promotions available to be redeemed to allow them the opportunity. In some embodiments, this service would be easily turned on or off, focused in only specific categories, to auto-collect and recommend or not, etc. depending on the appetite of the user. This data as well as the interaction with the resulting coupons, may inform the network of the user's intent. For instance, a user that is focused on photography and looking for deals for a specific camera may be expressing intent to purchase.

Some embodiments include a Mobile Coupon Application for the user that may or may provide any of the following: allow saving a promotional ad to an application space; allow retrieving a promotional ad saved from any device (mobile or not); provide a scannable image that when scanned triggers the promotion to be applied at the physical register from the mobile device; provide a printable version of the coupon; provide a code that can be applied for online consumer experiences; provide a configuration interface to control the coupon basket service to best serve the user (categories, specific vendors, specific items, etc.); provide seamless alerting mechanisms optimized for the consumption experience (online and offline); and, provide a life-vertisement option that is differentiated for promotional activities for the advertiser.

Some embodiments provide, or allow advertisers to do, any of the following: target coupons and promotions just like ads through the ad network; generate consumption profile data on users exposed to the campaign in terms of interaction, intention, and redemption rates; expressions for coupons and deals of several types, inserted as objects within the application platform of choice; feedback on campaign effectiveness with coupons; feedback on the return on discounted marketing activities in terms of redemption value; target specific users and optimize with coupons of varying intensity based on the rate of returns.

Some embodiments provide the following: a language to express deals, deal types; an engine to validate coupons in the basket for the user's context; an event processing and data generation for campaign feedback and optimization; and, instrumentation of coupons in context and in basket that are extracted from the ad distribution through the network. Some embodiments include utilization of one or more standardized models for offers, coupons, promotions, discounts, etc., as well as validation, resolution in context, and surfacing of such, and these may be incorporated into or as logic and data model elements of a Mobile Coupon Basket Application or Program, for example.

Some embodiment provide any of the following: an Ad Basket or Mobile Coupon Basket application offered by an ad network for users to ubiquitously (pc, mobile, etc.) surface the opportunity to save money in consumption activities; advertiser provisioning of coupons just like ads, potentially utilizing life-vertisements framework; instrumentation of basket events for closed-loop optimization, including adding a coupon to basket, which may evidence user intent to purchase, tagging as favorites, sharing, redemption of coupon, and tracking of additional items purchased alongside; resulting performance metrics and data employed to differentiate audience members; when activated, the Coupon Basket tunes into the context of the user (location from gps on mobile device, nearby or alternate venues or shopping sites, recent user interest in category, etc.) to proactively surface valid promotions that may save the user money; alert user when an opportunity to save money from a promotional offer is available but being passed up, along with choice to ignore; using consumers choices, interaction, activity, and configuration in the Coupon Basket to improve behavioral targeting information on users (holding out for a deal from advertiser, for preferred brand, etc); using data generated from the coupon basket to re-target users for the indicated brands or substitute products.

While the invention is described with reference to the above drawings, the drawings are intended to be illustrative, and the invention contemplates other embodiments within the spirit of the invention.

1. A method comprising:
using one or more server computers, providing a software-based application through which a user can store advertisements that the user enters or encounters online, and through which, for a stored advertisement, the user can store tag data associated with the stored advertisement, wherein the tag data is generated or selected by the user, and wherein the user can be a stationary user or a mobile user;
using one or more computers, upon detection of a set of one or more trigger conditions providing an indication of a potential particular use of a particular stored advertisement, providing an electronic alert to the user to alert the user to the potential particular use;
using one or more computers, tracking and storing user interaction information relating to interactions of the user with the particular stored advertisement; and
using one or more computers, utilizing the user interaction information in measuring performance of the particular stored advertisement.

2. The method of claim 1, comprising, via the application, providing the user with an ability to search for and retrieve a stored advertisement for use online.

3. The method of claim 1, wherein detection of a set of one or more trigger conditions comprises detection of an indication that the user has entered within a geographic area that is within a certain maximum distance from a location at which the potential particular use may occur.

4. The method of claim 1, wherein detection of a set of one or more trigger conditions comprises detection that the user is visiting a Web site at which the potential particular use may occur.

5. The method of claim 1, wherein measuring performance of the particular stored advertisement comprises measuring brand engagement value provided by the particular stored advertisement at least in part via interaction of the user with the particular stored advertisement.

6. The method of claim 1, wherein the user is a cell phone user.

7. The method of claim 1, wherein the user is a tablet user.

8. The method of claim 1, wherein the particular stored advertisement is a stored coupon.

9. The method of claim 1, wherein the stored interaction information includes information relating to storage by the user of the particular stored advertisement, information relating to storage by the user of tag data associated with the particular stored advertisement, and information relating to usage or application of the particular stored advertisement by the user.

10. The method of claim 1, wherein tag data is selected by the user via a graphical user interface.

11. The method of claim 1, wherein measuring performance of the particular stored advertisement is used to produce measurement information that is used in advertising campaign optimization.

12. The method of claim 1, comprising providing the user with an ability to configure particular parameters of operation of the application.

13. The method of claim 1, comprising targeting the user with an online advertisement based at least in part on usage of the application by the user.

14. The method of claim 1, wherein a first stored advertisement can include an advertisement that is or is incorporated into a software-based advertisement-associated application, and wherein user interactions with or through the advertisement-associated application is tracked, stored, and used in measuring performance of the first stored advertisement.

15. The method of claim 1, comprising, via the application, providing the user with social networking related abilities including sending or sharing of a first stored advertisement to or with users in a social network of the user.

16. A system comprising:
one or more server computers coupled to a network; and
one or more databases coupled to the one or more server computers;
wherein the one or more server computers are for:
providing a software-based application through which a user can store advertisements that the user encounters online, and through which, for a stored advertisement, the user can store tag data associated with the stored advertisement, wherein the tag data is generated or selected by the user, wherein the user can be a stationary user or a mobile user;
upon detection of a set of one or more trigger conditions providing an indication of a potential particular use of a particular stored advertisement, providing an electronic alert to the user to alert the user to the potential particular use;
tracking and storing user interaction information relating to interactions of the user with the particular stored advertisement; and
utilizing the user interaction information in measuring performance of the particular stored advertisement.

17. The system of claim 16, wherein at least one of the one or more server computers is coupled to the Internet.

18. The system of claim 16, wherein a first stored advertisement can include an advertisement that is or is incorporated into a software-based advertisement-associated application, and wherein user interactions with or through the advertisement-associated application is tracked, stored, and used in measuring performance of the first stored advertisement.

19. The method of claim 1, wherein measuring performance of the particular stored advertisement comprises measuring brand engagement provided by the particular stored advertisement at least in part via interaction of the user with the particular stored advertisement.

20. A computer readable medium or media containing instructions for executing a method comprising:
using one or more server computers, providing a software-based application through which a mobile user can store advertisements that the user encounters online, and through which, for a stored advertisement, the user can store tag data associated with the stored advertisement, wherein the tag data is generated or selected by the user;
using one or more computers, upon detection of a set of one or more trigger conditions providing an indication of a potential particular use of a particular stored advertisement, providing an electronic alert to the user to alert the user to the potential particular use;
wherein at least one of the set of one or more trigger conditions includes detecting that the user is within a particular physical distance from a physical location at which the potential particular use can occur;
using one or more computers, tracking and storing user interaction information relating to interactions of the user with the particular stored advertisement; and
using one or more computers, utilizing the user interaction information in measuring performance of the particular stored advertisement.
